(19) United States
(12) Patent Application Publication
(10) Pub. No.: US 2025/0212049 A1
(43) Pub. Date: Jun. 26, 2025

(54) PEER-TO-PEER COMMUNICATION IN WIRELESS NETWORKS

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Vishnu Vardhan Ratnam, Plano, TX (US); Yue Qi, Plano, TX (US)

(21) Appl. No.: 18/966,028

(22) Filed: Dec. 2, 2024

Related U.S. Application Data
(60) Provisional application No. 63/614,842, filed on Dec. 26, 2023.

(51) Int. Cl. H04W 28/02; H04W 28/10; H04W 28/24

(52) U.S. Cl. CPC H04W 28/0268; H04W 28/10; H04W 28/24

(57) ABSTRACT

A station (STA) in a wireless network, comprising a memory and a processor coupled to the memory, the processor configured to establish, with an access point (AP), a quality of service (QoS) flow for the first STA; and transmit, to the AP, a first frame indicating to terminate a QoS flow for a second STA that is established between eh AP and the second STA.

### CROSS-REFERENCE TO RELATED APPLICATION(S)

This application claims the benefit of priority from U.S. Provisional Application No. 63/614,842, entitled “SERVICE TERMINATION IN A P2P GROUP” filed Dec. 26, 2023, which is incorporated herein by reference in its entirety.

### TECHNICAL FIELD

This disclosure relates generally to a wireless communication system, and more particularly to, for example, but not limited to, peer-to-peer (P2P) communication in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a first station (STA) in a wireless network, comprising: a memory; and a processor coupled to the memory. The processor configured is to establish, with an access point (AP), a quality of service (QoS) flow for the first STA. The processor is configured to transmit, to the AP, a first frame indicating to terminate a QoS flow for a second STA that is established between the AP and the second STA.

In some embodiments, the first STA and the second STA belong to a peer-to-peer (P2P) group.

In some embodiments, the processor is further configured to transmit, to the AP, a second frame to establish a QoS flow between the AP and a third STA.

In some embodiments, the first frame includes an identifier for the second STA and timing information indicating a time after which the QoS flow for the second STA is terminated.

One aspect of the present disclosure provides an access point (AP) in a wireless network, comprising: a memory; and a processor coupled to the memory. The processor is configured to establish, with a first station (STA), a quality of service (QoS) flow for the first STA. The processor is configured to establish, with a second STA, a QoS flow for the second STA. The processor is configured to receive, from the first STA, a first frame indicating to terminate the QoS flow for the second STA that is established between the AP and the second STA. The processor is configured to terminate the QoS flow for the second STA in response to the first frame.

In some embodiments, the first STA and the second STA belong to a peer-to-peer (P2P) group.

In some embodiments, the processor is further configured to receive, from the first STA, a second frame to establish a QoS flow between the AP and a third STA, and establish, with the third STA, the QoS flow for the third STA in response to the second frame.

In some embodiments, the processor is further configured to establish a QoS flow for a particular STA by exchanging a stream classification service (SCS) request frame and a SCS response frame with the particular STA.

In some embodiments, the processor is further configured to continue to maintain the QoS flow for the first STA when the second STA is not a QoS negotiator for a QoS Agreement for the QoS flow for the first STA.

In some embodiments, the processor is further configured to modify the QoS flow for the first STA.

In some embodiments, the processor is further configured to terminate the QoS flow for the first STA when the second STA is a QoS negotiator for a QoS Agreement for the QoS flow for the first STA.

In some embodiments, the first frame includes an identifier for the second STA and timing information indicating a time after which the QoS flow for the second STA is terminated.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates an example network in accordance with an embodiment.

FIG. 5 illustrates an example environment of a device with latency-sensitive P2P traffic in accordance with an embodiment.

FIG. 6 illustrates peer STAs associated with a same AP in accordance with an embodiment.

FIG. 7 illustrates an example of terminating a quality of service (QoS) flow by one STA on behalf of another STA in accordance with an embodiment.

FIG. 8 illustrates an example of adding a new QoS flow by one STA on behalf of another STA in accordance with an embodiment.

FIG. 9 illustrates an example of continuing a QoS flow despite one STA's terminating the QoS flow in accordance with an embodiment.

FIG. 10 illustrates an example of terminating a QoS by an AP upon one STA's terminating the QoS flow in accordance with an embodiment.

FIG. 11 illustrates an example QoS flow rearrangement in a P2P group in accordance with an embodiment.

FIG. 12 illustrates an example of terminating a QoS flow by one STA on behalf of another STA in accordance with an embodiment.

FIG. 13 illustrates an example termination of a QoS flow by an STA in accordance with an embodiment.

FIG. 14 illustrates a flow chart of an example process by an STA for the QoS flow rearrangement in a QoS P2P group in accordance with an embodiment.

FIG. 15 illustrates a flow chart of an example process by an AP for the QoS flow rearrangement in a QoS P2P group in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

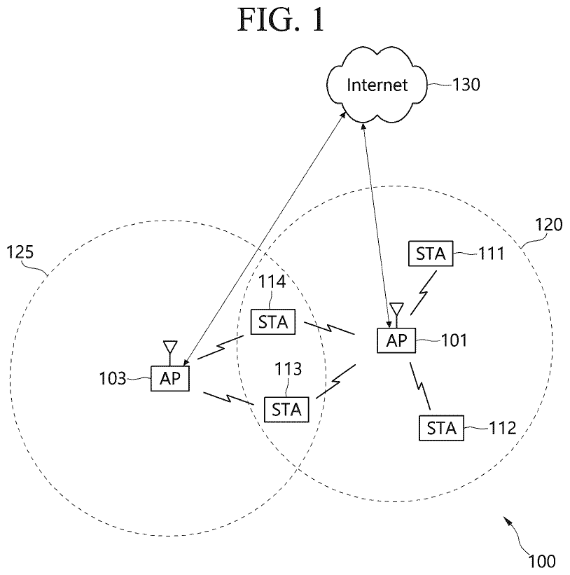

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

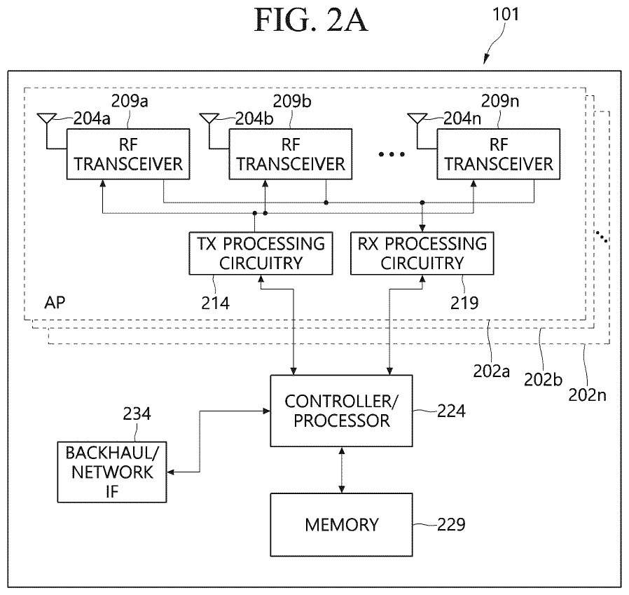

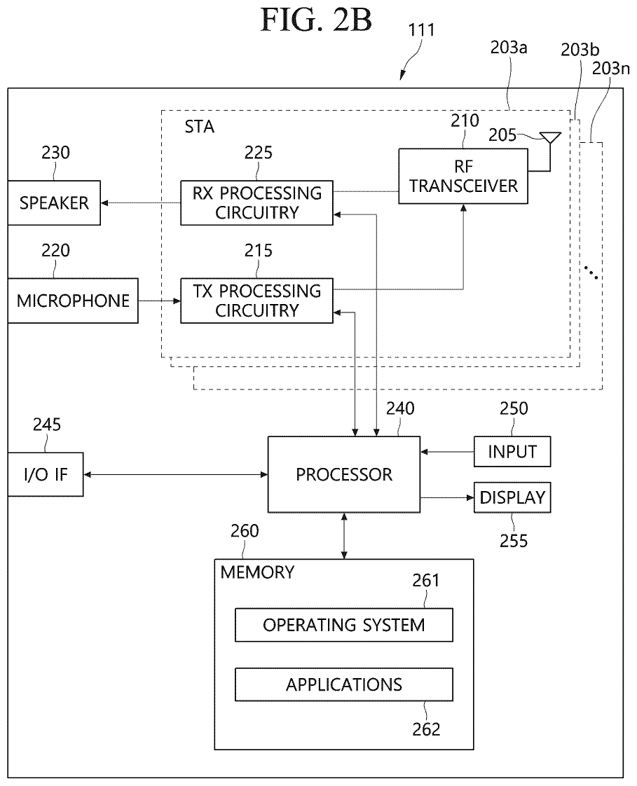

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementations of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

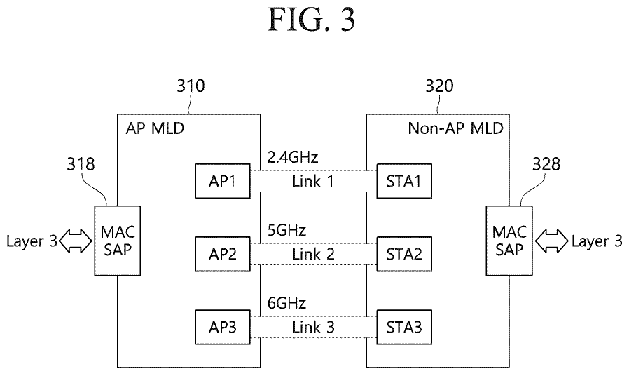

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Lazyer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and ii) IEEE P802.11bc/D4.0, “Wireless LAN Medium Access Control (MAC) and Physical Layer (PHY) Specifications.”

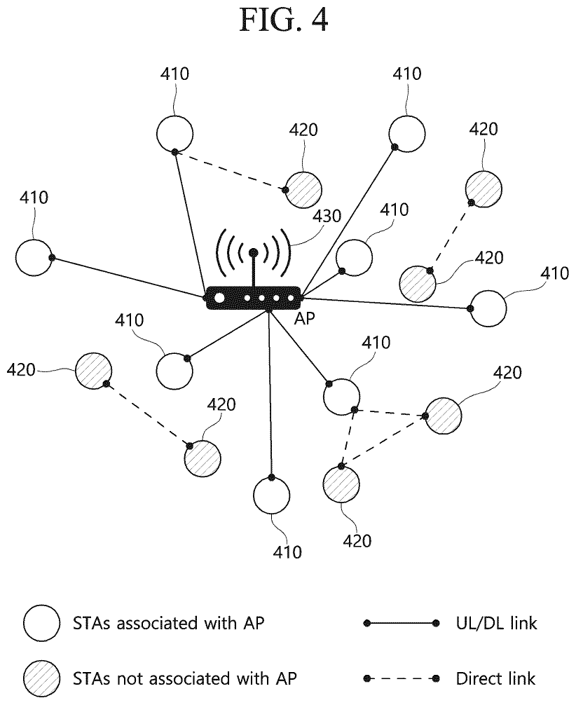

FIG. 4 shows an example network in accordance with an embodiment. The network depicted in FIG. 4 is for explanatory and illustration purposes. FIG. 4 does not limit the scope of this disclosure to any particular implementation.

In FIG. 4, a plurality of STAs 410 are non-AP STAs associated with AP 430, and a plurality of STAs 420 are non-AP STAs which are not associated with AP 430. Additionally, solid lines between STAs and AP 430 represent uplink or downlink with AP 430, while the dashed lines between STAs represent a direct link between STAs.

Next generation WLAN system needs to provide improved support for low-latency applications. Today, it is common to observe numerous devices operating on the same network. Many of these devices may have a tolerance for latency, but still compete with the devices running low-latency applications for the same time and frequency resources. In some cases, the AP as a network controller may not have enough control over the unregulated or unmanaged traffic that contends with the low-latency traffic within the infrastructure basic service set (BSS). In some embodiments, the infrastructure BSS is a basic service set that includes an AP and one or more non-AP STAs, while the independent BSS is a basic service set where non-AP STAs communicate with each other without the need for a centralized AP. Some of the unregulated or unmanaged traffic that interferes with the latency-sensitive traffic in the BSS of the AP may originate from uplink, downlink, or direct link communications within the infrastructure BSS that the AP manages. Another source of the interference may be transmission from the neighboring infrastructure OBSS (Overlapping Basic Service Set), while others may come from neighboring independent BSS or P2P networks. Therefore, the next generation WLAN system may benefit from mechanisms to more effectively handle unmanaged traffic while prioritizing low-latency traffic in the network.

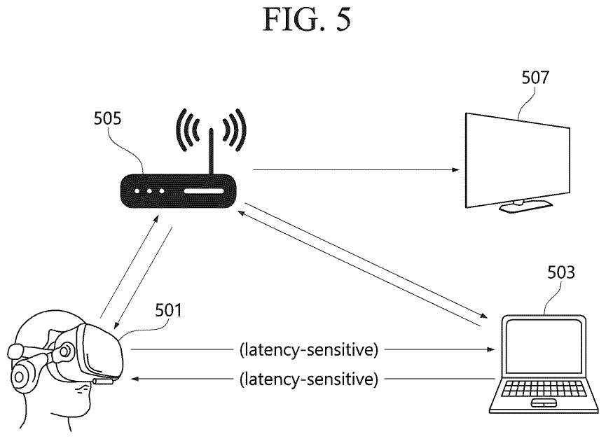

In a WLAN system with moderate or heavy traffic flow, a STA may not be able to get a chance to deliver its peer-to-peer traffic in a timely manner. If the STA has latency-sensitive traffic for another peer device, this may need to be delivered within a given delay bound. So, not being able to access the channel for peer-to-peer (P2P) communication can disrupt latency-sensitive applications. This is illustrated in FIG. 5 in accordance with an embodiment.

FIG. 5 illustrates an example environment where a device may need timely delivery of the latency-sensitive P2P traffic in accordance with an embodiment. In FIG. 5, a typical scenario of augmented reality (AR), virtual reality (VR), extended reality (XR), and mixed reality (MR) is illustrated. The head-mounted device (HMD) 501 and the companion device 503 (the laptop) may have latency-sensitive P2P traffic. The access point (AP) 505 may be delivering downlink traffic to other nodes, such as smart TV 507, and other nodes (e.g., smart TV 507) may also transmit uplink traffic.

Peer-to-peer (P2P) communication has become important for today's WLAN systems. In a heavily loaded environment, ensuring the Quality of service (QoS) requirement for P2P communication may be critical for the timely delivery of low-latency P2P traffic. The P2P traffic can be of two types, including (1) P2P traffic that flows through the AP or (2) P2P traffic that flows over the P2P direct link established between the two peer STAs. In some embodiments, a P2P group may refer to a group of devices that connect directly to each other without need to connect with an intermediate AP.

In P2P traffic that flows through the AP, one of the peer STAs may first send the frames to the AP, where the frames are destined for another peer device. The AP then forwards the frames to the destination peer STA. This may require both of the P2P STAs to be associated with the AP.

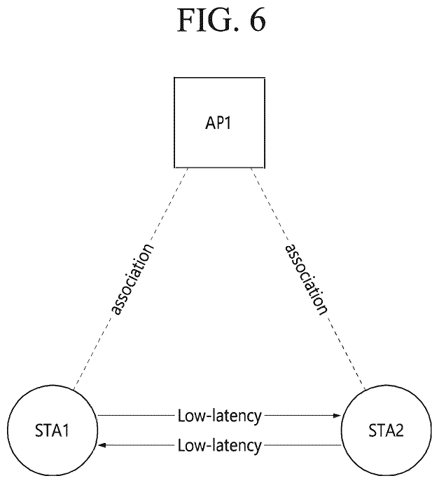

FIG. 6 illustrates peer STAs associated with a same AP in accordance with an embodiment. In particular, FIG. 6 illustrates peer STA1 and peer STA2 associated with a same AP, API. For P2P traffic that flows over the P2P direct link established between the two peer STAs (STA1 and STA2), if the P2P direct link is a Tunneled Direct Link Setup (TDLS) link, then both peer STAs (STA1 and STA2) may need to be associated with the same AP (AP1). If the P2P direct link is Wi-Fi Direct or Wi-Fi Aware link, then there is no requirement of either of the P2P STAs (STA1 and STA2) to be associated with any AP at all. However, either or both of the P2P STA (STA1 and STA2) may still be associated with the same or different APs.

In some embodiments, for the scenario where a first STA and a second STA in a P2P group establish a QoS flow with their associated AP, the first STA can terminate the QoS flow for the second STA on behalf of the second STA. In some embodiments, a QoS flow may be established using a Stream Classification Service (SCS) request-response process.

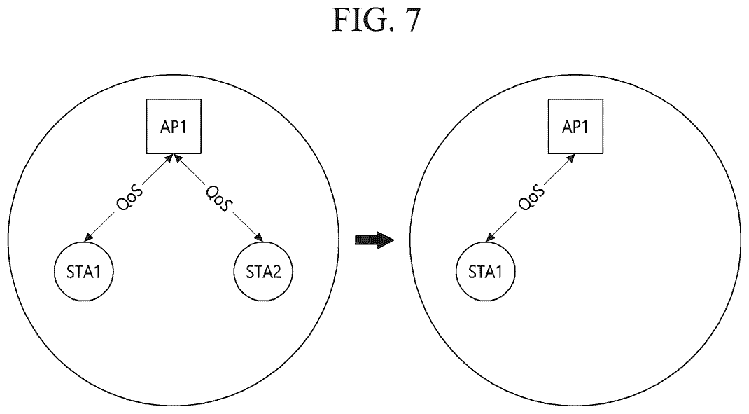

FIG. 7 illustrates terminating a QoS flow by one STA on behalf of another STA in accordance with an embodiment. In FIG. 7, STA1 and STA2 both are part of a QoS negotiation with the AP (AP1) and both STAs (STA1 and STA2) have P2P traffic flowing between them. In a later phase, STA1 sends a message (e.g. a frame) to AP1 indicating to AP1 to terminate the QoS flow for STA2.

In some embodiments, for the scenario where a first STA establishes a QoS flow with its AP, the first STA can add a new QoS flow for a second STA that is a peer STA of the first STA.

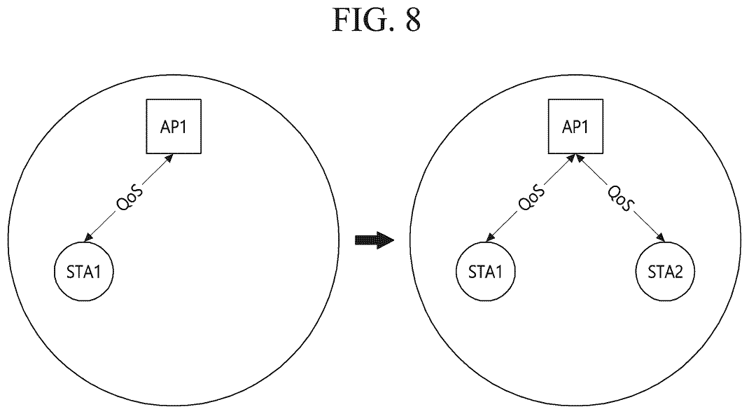

FIG. 8 illustrates adding a new QoS flow by one STA on behalf of another STA in accordance with an embodiment. In FIG. 8, STA1 first establishes a QoS flow with AP1. In a later phase, STA1 adds a QoS flow for STA2. The QoS flow can be either an existing QoS flow or a newly added QoS flow.

In some embodiments, for the scenario where two STAs in a P2P group establish a QoS flow with their associated AP, if one of the STAs terminates the QoS flow, then the AP can continue to serve (e.g. provide resources) the other STA in the P2P group.

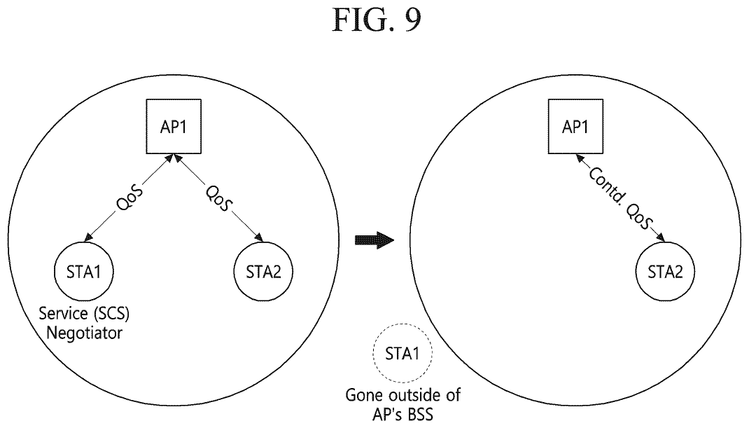

FIG. 9 illustrates an example that a QoS flow continues despite one STA's terminating the QoS flow in accordance with an embodiment. In FIG. 9, STA1 and STA2 both are part of a QoS negotiation with the AP (AP1) and both STAs have P2P traffic flowing between them. In this example, STA1 is the Service (SCS) Negotiator (e.g., QoS Negotiator). In some embodiments, the Service (SCS) Negotiator may be referred to as a QoS negotiator that negotiates a QoS agreement for a QoS flow for itself and/or on behalf of one or more other STAs.

In a later phase, STA1 terminates the QoS flow with AP1. For example, STA1 may go outside of AP1's BSS. However, AP1 continues to maintain the QoS flow for the remaining STA (STA2) in the P2P group.

In some embodiments, for the scenario where two STAs in a P2P group establish a QoS flow (e.g., using SCS request-response process) with their associated AP, if one of the STAs terminates the QoS flow, then the AP can stop serving (e.g. providing resources to) the other STA in the P2P group as well.

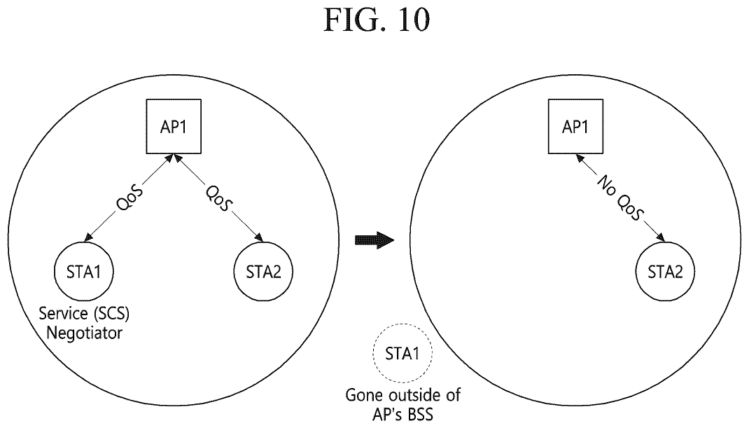

FIG. 10 illustrates an example that a QoS flow is terminated by the AP upon one STA's terminating the QoS flow in accordance with an embodiment. In FIG. 10, STA1 and STA2 both are part of a QoS negotiation with the AP (AP1) and both STAs have P2P traffic flowing between them. In this example, STA1 is the Service (SCS) Negotiator (e.g., QoS Negotiator). In a later phase, STA1 terminates the QoS flow with AP1. For example, STA1 may go outside of AP1's BSS. Consequently, AP1 also terminates the QoS flow for STA2 as well in the P2P.

In some embodiments, for the scenario where two STAs (a first STA and a second STA) in a P2P group establish a QoS flow with their associated AP, if one of the STAs (the first STA) terminates the QoS flow, then the AP can stop to serve the other STA (the second STA) in the P2P group as well if the first STA was the QoS negotiator (e.g., STA1 in FIG. 9 and FIG. 10 illustrated as Service (SCS) Negotiator) for that traffic flow with the AP. If the first STA was not the QoS negotiator for the QoS agreement for that QoS flow, then AP can continue to serve the second STA according to the existing QoS negotiation.

The described embodiments herein may be extended to P2P groups with more than two STAs. In some embodiments, QoS flow addition and deletion for multiple STAs can be performed with the QoS P2P group.

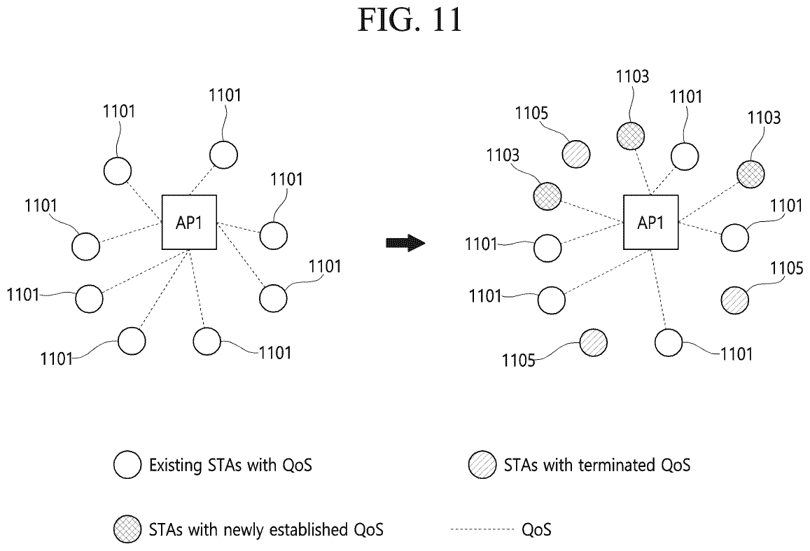

FIG. 11 illustrates QoS rearrangement in a P2P group in accordance with an embodiment. As illustrated, in a first phase, an AP, AP1, may have a QoS flow with a plurality of STAs 1101. At a later phase, AP1 may have QoS flows with several existing STAs 1101. AP1 may also establish new QoS flows with several STAs 1103 and terminate QoS flows with several STAs 1105.

In some embodiments, a QoS Termination Request frame can be used to indicate termination of an existing QoS flow for a STA. The QoS Termination Request frame may include a QoS Termination Request element which may have the following fields: Element ID, Element ID extension, one or more identifiers for the STAs for which the QoS flow is being requested to be terminated, one or more identifiers for the QoS flow that is being requested to be terminated, timing information indicating the time (or counter) after which the QoS flow is being requested to be terminated.

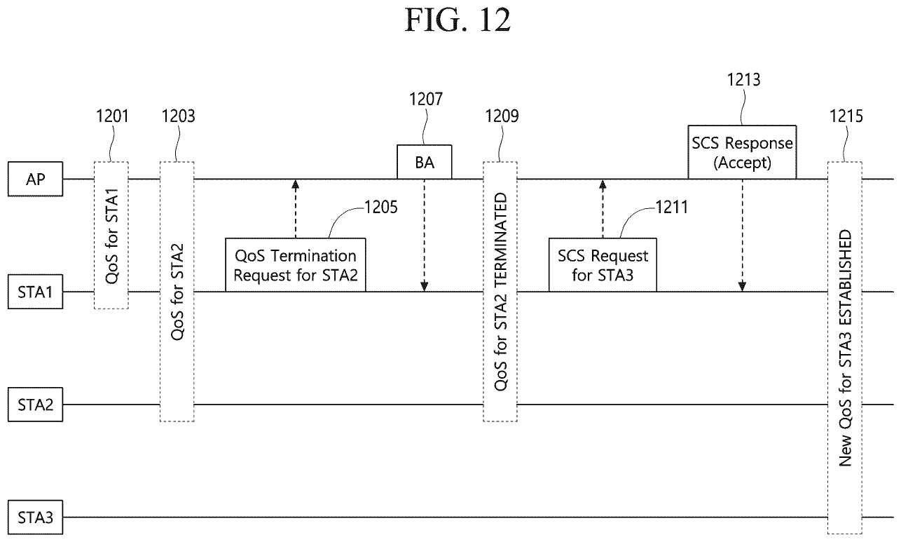

FIG. 12 illustrates an example process of a QoS flow termination by one STA on behalf of another STA in accordance with an embodiment. In particular, FIG. 12 illustrates communication between an AP, STA1, STA2, and STA3. Although one or more operations are described or shown in particular sequential order, in other embodiments the operations may be rearranged in a different order, which may include performance of multiple operations in at least partially overlapping time periods.

In operation 1201, a QoS flow is established between the AP and STA1. In some embodiments, the AP and STA1 may use an SCS request-response procedure to establish the QoS with the STA1.

In operation 1203, a QoS flow is established between the AP and STA2. In some embodiments, the AP and STA2 may use an SCS request-response procedure to establish the QoS with the STA2.

In operation 1205, the STA1 transmits, to the AP, a QoS Termination Request for STA2. In some embodiments, a QoS Termination Request frame can be used to indicate termination of an existing QoS flow for a STA. The QoS Termination Request frame may include a QoS Termination Request element which may have the following fields: Element ID, Element ID extension, one or more identifiers for the STAs for which the QoS flow is being requested to be terminated, one or more identifiers for the QoS flow that is being requested to be terminated, timing information indicating the time (or counter) after which the QoS flow is being requested to be terminated.

In operation 1207, in response to the QoS Termination Request, the AP transmits, to STA1, a block acknowledgement.

In operation 1209, the QoS flow for STA2 is terminated by the AP.

In operation 1211, STA1 transmits, to the AP, a SCS Request for STA3 to negotiate and establish a QoS flow for STA3.

In operation 1213, the AP transmits, to STA1, a SCS Response with a status indicated as accept the SCS Request.

In operation 1215, the AP establishes a new QoS flow for STA3.

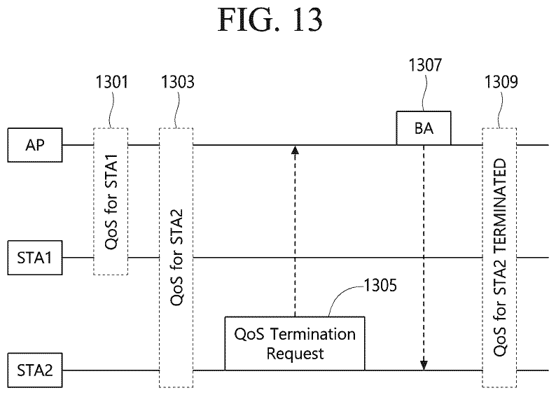

FIG. 13 illustrates an example process of a QoS flow termination by the STA that intends to terminate the QoS flow in accordance with an embodiment. In particular, FIG. 13 illustrates communications between an AP, STA1, and STA2. Although one or more operations are described or shown in particular sequential order, in other embodiments the operations may be rearranged in a different order, which may include performance of multiple operations in at least partially overlapping time periods.

In operation 1301, a QoS flow is established between the AP and STA1. In some embodiments, the AP and STA1 may use an SCS request-response procedure to establish the QoS with the STA1.

In operation 1303, a QoS flow is established between the AP and STA2. In some embodiments, the AP and STA2 may use an SCS request-response procedure to establish the QoS with the STA2.

In operation 1305, STA2 transmits, to the AP, a QoS Termination Request. In some embodiments, a QoS Termination Request frame can be used to indicate termination of an existing QoS flow for a STA. The QoS Termination Request frame may include a QoS Termination Request element which may have the following fields: Element ID, Element ID extension, one or more identifiers for the STAs for which the QoS flow is being requested to be terminated, one or more identifiers for the QoS flow that is being requested to be terminated, timing information indicating the time (or counter) after which the QoS flow is being requested to be terminated.

In operation 1307, in response to the QoS Termination Request, the AP transmits, to STA2, a block acknowledgement.

In operation 1309, the QoS flow for STA2 is terminated by the AP.

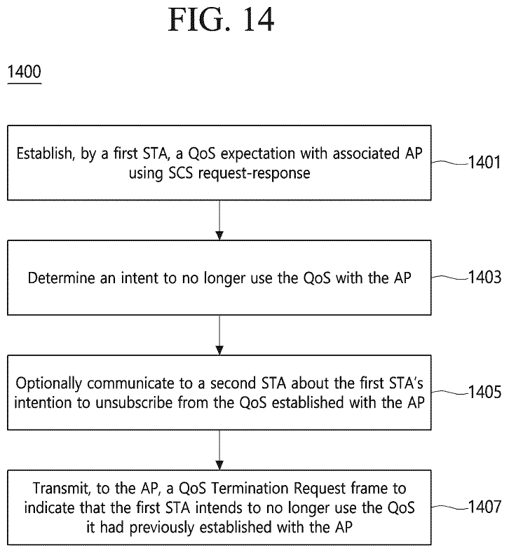

FIG. 14 illustrates a flow chart of an example process 1400 by an STA for the QoS flow rearrangement in a QoS P2P group in accordance with an embodiment. Although one or more operations are described or shown in particular sequential order, in other embodiments the operations may be rearranged in a different order, which may include performance of multiple operations in at least partially overlapping time periods.

The process 1400 begins in operation 1401.

In operation 1401, a first STA establishes a QoS expectation with an associated AP. In some embodiments, the first STA may use an SCS request-response procedure to establish the QoS with the AP.

In operation 1403, the first STA may determine an intent to no longer use the QoS flow with the AP. For example, the first STA intends to go outside of the AP's basic service set (BSS).

In operation 1405, the first STA can optionally communicate to a second STA associated with the AP about the first STA's intention to unsubscribe from the QoS established with the AP.

In operation 1407, the first STA may transmit to the AP a QoS Termination Request frame to indicate that the first STA intends to no longer use the QoS it had previously established with the AP. In some embodiments, the second STA may send the QoS Termination Request frame on behalf of the first STA to indicate that the first STA no longer intends to use the QoS flow with the AP. In some embodiments, a QoS Termination Request frame can be used to indicate termination of an existing QoS flow for a STA. The QoS Termination Request frame may include a QoS Termination Request element which may have the following fields: Element ID, Element ID extension, one or more identifiers for the STAs for which the QoS flow is being requested to be terminated, one or more identifiers for the QoS flow that is being requested to be terminated, timing information indicating the time (or counter) after which the QoS flow is being requested to be terminated.

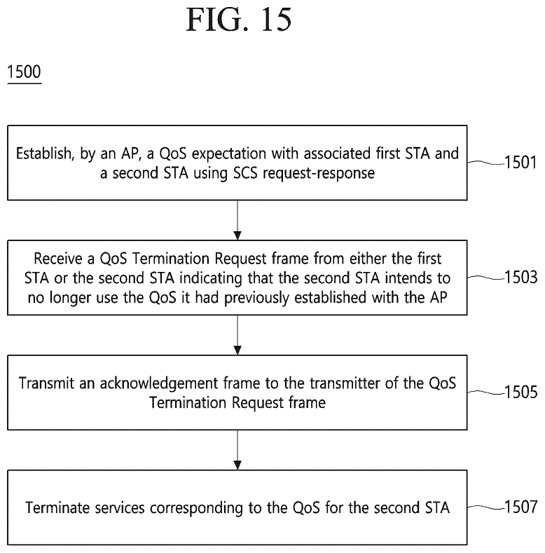

FIG. 15 illustrates a flow chart of an example process by an AP for the QoS flow rearrangement in a QoS P2P group in accordance with an embodiment. Although one or more operations are described or shown in particular sequential order, in other embodiments the operations may be rearranged in a different order, which may include performance of multiple operations in at least partially overlapping time periods.

The process begins in operation 1501.

In operation 1501, the AP establishes a QoS expectation with an associated first STA and a second STA. In some embodiments, the AP may use an SCS request-response procedure to establish the QoS flow.

In operation 1503, the AP receives a QoS Termination Request frame from either the first STA or the second STA indicating that the second STA intends to no longer use the QoS flow it had previously established with the AP. In some embodiments, a QoS Termination Request frame can be used to indicate termination of an existing QoS flow for a STA. The QoS Termination Request frame may include a QoS Termination Request element which may have the following fields: Element ID, Element ID extension, one or more identifiers for the STAs for which the QoS flow is being requested to be terminated, one or more identifiers for the QoS flow that is being requested to be terminated, timing information indicating the time (or counter) after which the QoS flow is being requested to be terminated.

In operation 1505, the AP transmits an acknowledgement frame to the transmitter of the QoS Termination Request frame (e.g., the first STA or the second STA).

In operation 1507, the AP terminates the services corresponding to the QoS flow for the second STA.

Embodiments in accordance with this disclosure provide mechanisms and protocols for operating QoS-based P2P groups, which can facilitate communications between devices in P2P groups, including adding new devices to an existing P2P group and/or modifying or deleting an existing device in the P2P group, to improve communication between the devices in the P2P groups. In particular, embodiments in accordance with this disclosure provide mechanisms to handle situations where one device in a P2P group leaves a BSS, which includes maintaining one or more QoS flows for other devices in the P2P group. Likewise, procedures to add new devices to existing QoS flows for a P2P group and/or modifying or deleting procedures for QoS flows are disclosed herein.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first station (STA) in a wireless network, comprising:
a memory; and
a processor coupled to the memory, the processor configured to:
establish, with an access point (AP), a quality of service (QoS) flow for the first STA; and
transmit, to the AP, a first frame indicating to terminate a QoS flow for a second STA that is established between the AP and the second STA.

2. The first STA of claim 1, wherein the first STA and the second STA belong to a peer-to-peer (P2P) group.

3. The first STA of claim 1, wherein the processor is further configured to transmit, to the AP, a second frame to establish a QoS flow between the AP and a third STA.

4. The first STA of claim 1, wherein the first frame includes an identifier for the second STA and timing information indicating a time after which the QoS flow for the second STA is terminated.

5. An access point (AP) in a wireless network, comprising:
a memory; and
a processor coupled to the memory, the processor configured to:
establish, with a first station (STA), a quality of service (QoS) flow for the first STA;
establish, with a second STA, a QoS flow for the second STA;
receive, from the first STA, a first frame indicating to terminate the QoS flow for the second STA that is established between the AP and the second STA; and
terminate the QoS flow for the second STA in response to the first frame.

6. The AP of claim 5, wherein the first STA and the second STA belong to a peer-to-peer (P2P) group.

7. The AP of claim 5, wherein the processor is further configured to:
receive, from the first STA, a second frame to establish a QoS flow between the AP and a third STA; and
establish, with the third STA, the QoS flow for the third STA in response to the second frame.

8. The AP of claim 5, wherein the processor is further configured to establish a QoS flow for a particular STA by exchanging a stream classification service (SCS) request frame and a SCS response frame with the particular STA.

9. The AP of claim 5, wherein the processor is further configured to continue to maintain the QoS flow for the first STA when the second STA is not a QoS negotiator for a QoS Agreement for the QoS flow for the first STA.

10. The AP of claim 5, wherein the processor is further configured to modify the QoS flow for the first STA.

11. The AP of claim 5, wherein the processor is further configured to terminate the QoS flow for the first STA when the second STA is a QoS negotiator for a QoS Agreement for the QoS flow for the first STA.

12. The AP of claim 5, wherein the first frame includes an identifier for the second STA and timing information indicating a time after which the QoS flow for the second STA is terminated.

13. A computer implemented method for communication, by an access point (AP), in a wireless network, comprising:
establishing, with a first station (STA), a quality of service (QoS) flow for the first STA;
establishing, with a second STA, a QoS for the second STA;
receiving, from the first STA, a first frame indicating to terminate the QoS flow for the second STA that is established between the AP and the second STA; and
terminate the QoS Flow for the second STA in response to the first frame.

14. The computer-implemented method of claim 13, wherein the first STA and the second STA belong to a peer-to-peer (P2P) group.

15. The computer-implemented method of claim 13, further comprising:
receiving, from the first STA, a second frame to establish a QoS flow between the AP and a third STA; and
establish, with the third STA, the QoS flow for the third STA in response to the second fame.

16. The computer-implemented method of claim 13, further comprising establishing a QoS flow for a particular STA by exchanging a stream classification service (SCS) request frame and a SCS response frame with the particular STA.

17. The computer-implemented method of claim 13, further comprising maintaining the QoS flow for the first STA when the second STA is not a QoS negotiator for a QoS Agreement for the QoS flow for the first STA.

18. The computer-implemented method of claim 13, wherein the processor is further configured to modify the QoS flow for the first STA.

19. The computer-implemented method of claim 13, further comprising terminating the QoS flow for the first STA when the second STA is a QoS negotiator for a QoS Agreement for the QoS flow for the first STA.

20. The computer-implemented method of claim 13, wherein the first frame includes an identifier for the second STA and timing information indicating a time after which the QoS flow for the second STA is terminated.
